(19) United States
(12) Patent Application Publication
(10) Pub. No.: US 2024/0212377 A1
(43) Pub. Date: Jun. 27, 2024

(54) CUSTOM OBJECT TRACKING USING HYBRID MACHINE LEARNING

(71) Applicant: LUMANA INC., Sunnyvale, CA (US)

(72) Inventors: Ofir MULLA, Talme Elazar (IL); Noam ROTSTEIN, Haifa (IL); Amit BRACHA, Haifa (IL); Ron KIMMEL, Haifa (IL); Aviad ZABATANI, Kfar Vitkin (IL); Ron SLOSSBERG, Raanana (IL); Sagi BEN MOSHE, Ein Ayala (IL)

(73) Assignee: LUMANA INC., Sunnyvale, CA (US)

(21) Appl. No.: 18/186,517

(22) Filed: Mar. 20, 2023

Related U.S. Application Data
(63) Continuation-in-part of application No. 18/145,301, filed on Dec. 22, 2022.

(51) Int. Cl. G06V 30/19

(52) U.S. Cl. CPC G06V 30/19147; G06V 30/1912; G06V 30/19173

(57) ABSTRACT

Systems and methods for visual content processing. A method includes applying teacher models to training candidates in order to output instances of a custom object label. The training candidates are selected using a student model based on search configuration parameters. A first set of media content is generated by labeling the training candidates based on the instances of the custom object label output by the teacher models. A custom model is created using the teacher models. The custom model is a machine learning model trained using the first set of media content. A subset of a second set of media content is obtained. The subset of the second set of media content is selected based on outputs of the custom model as applied to the second set of media content. An advanced machine learning model is applied to the obtained subset of the second set of media content.

### CROSS-REFERENCE TO RELATED APPLICATIONS

This application is a continuation-in-part of U.S. patent application Ser. No. 18/145,301 filed on Dec. 22, 2022, now pending, the contents of which are hereby incorporated by reference.

### TECHNICAL FIELD

The present disclosure relates generally to processing content such as images using machine learning, and more specifically to training and using machine learning models for tracking custom objects.

### BACKGROUND

With the rapid adoption of computerized monitoring technologies, the amount of media content being captured and processed has exploded in recent years. With this explosion of media content that needs to be analyzed and processed, the need for efficient ways to process this vast amount of data is more acute than ever. Video monitoring technologies are being used for many different purposes, such as home monitoring (e.g., video doorbells which watch for activity outside of a door), vehicle monitoring (e.g., systems which monitor video for parking or other vehicle-related violations), hospitality (e.g., video monitoring inside of hotels), and many more. Although software can be installed locally where the media content is captured, processing such large amounts of media content presents a challenge and not all sites are equipped with the computing resources to handle such processing.

Additionally, these monitoring technologies would benefit from solutions which facilitate central management. Many of these monitoring technologies are used by large companies with many sites worldwide. Solutions which allow for providing a single portal that manages all videos being captured at these various worldwide locations are therefore desirable.

Moreover, as these kinds of monitoring services are being increasingly offered to users for different types of implementations, the need for custom object classification and tracking becomes more relevant. Specifically, users may wish to use video monitoring in order to monitor for custom, user-defined objects which may not be known to the system (e.g., through machine learning training or otherwise through an initial configuration of the system). For example, a user who wishes to monitor objects produced in their factory or shipped from their warehouse may want the monitoring service to identify the appearance of the manufactured objects in video from the factory even though a machine learning model used for the monitoring service is not trained to recognize their manufactured objects. Some existing solutions utilize a large amount of training samples that are manually selected, labeled, or otherwise prepared by the user, but this solution is cumbersome and subject to human error.

Solutions which would more efficiently process large volumes of media content are therefore highly desirable. It would further be beneficial for such solutions to allow for custom definitions of objects in order to facilitate monitoring with respect to objects which are not already known to the relevant systems.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for visual content processing. The method comprises: applying teacher models to a set of training candidates in order to output a plurality of instances of a custom object label, wherein the set of training candidates is selected using a student model, wherein the student model is configured to select the set of training candidates from among a set of media content based on at least one search configuration parameter, wherein the at least one search configuration parameter defines criteria for selecting samples to be used as the set of training candidates; generating a first set of media content by labeling the plurality of training candidates based on the plurality of instances of the custom object label output by the teacher models; creating a custom model using the teacher models, wherein the custom model is a machine learning model trained using the first set of media content; obtaining a subset of a second set of media content, wherein the subset of the second set of media content is selected based on outputs of the custom model as applied to the second set of media content, wherein the outputs of the custom model include at least one first prediction for the subset of the second set of media content; and applying an advanced machine learning model to the obtained subset of the second set of media content, wherein a domain used by the custom model is a subset of a domain used by the advanced machine learning model.

Certain embodiments disclosed herein also include a non-transitory computer readable medium having stored thereon causing a processing circuitry to execute a process, the process comprising: applying teacher models to a set of training candidates in order to output a plurality of instances of a custom object label, wherein the set of training candidates is selected using a student model, wherein the student model is configured to select the set of training candidates from among a set of media content based on at least one search configuration parameter, wherein the at least one search configuration parameter defines criteria for selecting samples to be used as the set of training candidates; generating a first set of media content by labeling the plurality of training candidates based on the plurality of instances of the custom object label output by the teacher models; creating a custom model using the teacher models, wherein the custom model is a machine learning model trained using the first set of media content; obtaining a subset of a second set of media content, wherein the subset of the second set of media content is selected based on outputs of the custom model as applied to the second set of media content, wherein the outputs of the custom model include at least one first prediction for the subset of the second set of media content; and applying an advanced machine learning model to the obtained subset of the second set of media content, wherein a domain used by the custom model is a subset of a domain used by the advanced machine learning model.

Certain embodiments disclosed herein also include a system for visual content processing. The system comprises: a processing circuitry; and a memory, the memory containing instructions that, when executed by the processing circuitry, configure the system to: apply a teacher model to a set of training candidates in order to output a plurality of instances of a custom object label, wherein the set of training candidates is selected using a student model, wherein the student model is configured to select the set of training candidates from among a set of media content based on at least one search configuration parameter, wherein the at least one search configuration parameter defines criteria for selecting samples to be used as the set of training candidates; generate a first set of media content by labeling the plurality of training candidates based on the plurality of instances of the custom object label output by the teacher models; create a custom model using the teacher models, wherein the custom model is a machine learning model trained using the first set of media content; obtain a subset of a second set of media content, wherein the subset of the second set of media content is selected based on outputs of the custom model as applied to the second set of media content, wherein the outputs of the custom model include at least one first prediction for the subset of the second set of media content; and apply an advanced machine learning model to the obtained subset of the second set of media content, wherein a domain used by the custom model is a subset of a domain used by the advanced machine learning model.

Certain embodiments disclosed herein also include a method for visual content processing. The method comprises: applying a custom machine learning model to a set of first media content, wherein the custom machine learning model is trained using a set of second media content, wherein the set of second media content is generated by labeling a plurality of training candidates based on a plurality of predictions output by teacher models, wherein the plurality of prediction labels includes at least one instance of a custom object label, wherein the outputs of the custom machine learning model include at least one prediction for the set of first media content; selecting a subset of the first media content based on the at least one prediction for the set of first media content output by the custom machine learning model; and providing the selected subset of the first media content as inputs to an advanced machine learning model, wherein a domain used by the custom machine learning model is smaller than a domain used by the advanced machine learning model.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2A is a flow diagram illustrating training of machine learning models for custom object detection in a hybrid machine learning architecture in accordance with various disclosed embodiments.

FIG. 2B is a flow diagram illustrating creation and deployment of a custom model in accordance with various disclosed embodiments.

FIG. 3 is a flow diagram illustrating distributed processing of content in accordance with various disclosed embodiments.

FIG. 4 is a flowchart illustrating a method for processing visual content at an edge of a distributed architecture according to an embodiment.

FIG. 5 is a flowchart illustrating a method for training a custom model according to an embodiment.

FIG. 6 is a flowchart illustrating a method for processing visual content at an advanced analyzer of a distributed architecture according to an embodiment.

FIG. 7 is a schematic diagram of a cloud analyzer according to an embodiment.

FIG. 8 is a schematic diagram of an edge analyzer according to an embodiment.

### DETAILED DESCRIPTION

The various disclosed embodiments include methods and systems making up a hybrid machine learning architecture for processing of visual content such as images as well as techniques for analyzing visual content using the hybrid architecture. The disclosed embodiments utilize a distributed architecture for machine learning training between teacher models and a student model in order to create a custom model trained to make predictions in line with the teacher models' predictions with respect to customized definitions of objects.

Specifically, a custom model is created using teacher models based on prediction labels generated by the teacher models when applied to select training candidates. The training candidates are portions of content identified by a student model, where the student model is initially configured based on one or more search configuration parameters to be used for selecting content which might contain instances of a user-defined custom object. To this end, a user may provide sample portions of content showing the desired custom object to be learned by the machine learning models, a custom object label to be used for labeling content or portions thereof showing the custom object, and one or more custom object search configuration parameters for obtaining additional content to be used as training candidates demonstrating examples of the custom object. As a non-limiting example when the custom object is a loaf of bread, a user may provide an image of a loaf of bread in its packaging at a factory as well as a custom label “bread loaf” and search parameters defining that training candidate images should be collected when motion is identified in those images.

During training, the student model is configured to identify content to be used as training candidates, and the training candidates identified by the student model may be uploaded to the teacher models for analysis and labeling. More specifically, the student model identifies sample content using the custom object search configuration parameters in order to derive training candidates which can be used to help train the student model to identify the custom object. To this end, the custom object search parameters may be defined with respect to randomized sampling or with respect to one or more other criteria. For example, images being captured at a factory may be randomly sampled from, or images captured at the factory at the time of motion being detected (i.e., indicating that an object is moving by the camera) may be identified as the training candidates. The training candidates are provided to the teacher models, thereby allowing for generating teacher prediction labels and labeling the training candidates accordingly by the teacher models. The teacher models, in turn, use the labeled content created by labeling the training candidates in order to generate a custom model configured to identify instances of the custom object within content.

Once the custom model is created, the custom model may be deployed at an edge device and utilized to make basic predictions about visual content in order to select potentially interesting portions of visual content for further analysis. The potentially interesting portions of visual content may be provided to one or more advanced models, which may be deployed remotely (e.g., on a cloud server), for more detailed analysis. The outputs of the advanced model may be utilized for enriching the potentially interesting portions of the visual content with their respective analysis results, for generating more accurate student models whose outputs better fit the input visual content, or both. In various embodiments, enriched visual content may be provided for display on a dashboard.

At least some disclosed embodiments leverage a hybrid architecture including one or more edge analyzers and one or more remote analyzers such as cloud analyzers. Each of the edge analyzers is configured with a custom model trained with a cloud model used by the remote analyzers, where each custom model is trained as a student model by the cloud model acting as a teacher model. Each edge analyzer may be deployed on site or otherwise locally to a system that captures or otherwise collects visual content to be analyzed. Each remote analyzer may be deployed in a cloud computing environment or otherwise deployed remotely to the edge analyzers.

The disclosed embodiments allow for custom defining objects which may not be represented in the initial training data used to initially configure the teacher machine learning model. This, in turn, allows users to define custom classes to be utilized by machine learning models without requiring explicit programming or otherwise providing a large amount of text for training. Moreover, various disclosed embodiments provide techniques which obtain content to be used for training which does not require multiple initial samples showing the custom-defined objects in order to train the resulting machine learning models to accurately identify the custom-defined objects.

In addition to advantages related to the amount of explicit configuring required, the disclosed embodiments may be realized with all training of content occurring exclusively between the teacher and student models. Likewise, all utilization of content may occur exclusively between advanced and custom models. The result of realizing training and utilization of content exclusively between the respective models used for such purposes is that the disclosed embodiments can be implemented securely. Consequently, the disclosed embodiments also provide techniques which allow for increasing security and privacy of content such as images by minimizing the need to expose the content outside of the respective models which will analyze the content.

The disclosed embodiments may be utilized for image processing in situations where a large amount of image data is continuously collected in order to perform basic analysis of those images using the custom model deployed at an edge device and to only perform advanced analyses of the images when the basic analysis yields predictions indicating that those images are potentially interesting, for example, when the custom model outputs predictions indicating that certain images show the custom object. To this end, in accordance with various disclosed embodiments, the custom model may be trained on a subset of the feature domain used by the teacher models such that applying the custom model created as described herein requires less processing than applying teacher models or other more advanced models. Accordingly, the disclosed embodiments can reduce total processing of content by limiting the amount of analysis performed using heavier models (e.g., models which have larger feature domains, more granular analysis, more kinds of outputs, otherwise require more processing, etc.) as enabled by a lighter model.

Additionally, the outputs of the custom model or the advanced model may be utilized in order to modify the content to be provided to the advanced models among the potentially interesting visual content. As a non-limiting example, portions of images identified as potentially interesting may be cropped from the images, and the cropped portions of the images may be sent for analysis by a cloud model acting as the advanced model. In this regard, the amount of processing performed by the advanced model, as well as network resources (e.g., bandwidth) used for transmitting the content, may be further reduced.

The hybrid approaches described herein can be utilized in order to allow customers or other end users to leverage their existing resources in order to preprocess image data for analysis by a remote system such as a cloud server. Specifically, the trained student model may be trained as a custom model, for example a custom model to be utilized by an edge device, in order to perform basic analysis, and only certain portions of the content identified as potentially interesting based on the basic analysis may be sent to one or more advanced models, for example advanced models deployed as cloud models on a cloud device. This distribution of processing can enable new opportunities for processing content which would not be feasible due to high use of computing resources which would be needed to fully analyze all of the content directly using the advanced model, which may be a heavier model configured to make predictions on a larger feature set, to make predictions from among a larger set of potential predictions, or both, than the basic model but requires more computing resources to run than the basic model.

As a non-limiting example, the disclosed embodiments can utilize a hybrid architecture including an edge server deployed on premises with a customer's cameras in order to apply the custom model to images captured locally by the customer's cameras in a warehouse owned or operated by the customer which packages goods in shipping containers such that it is desirable to be able to identify the shipping containers as they move within the warehouse. The custom model may be configured to classify portions of images as either showing a shipping container custom object or not showing a shipping container. Images or portions of images classified as showing shipping containers based on the outputs of the custom model are determined as potentially interesting and sent from the edge server to a cloud server having an advanced model for further processing. An advanced model is configured to analyze the images determined as showing shipping containers with more granularity in order to determine, for example, a specific type of shipping container (e.g., box versus mailing tube), text of a container identifier (ID) label shown on the shipping container, or other more specific information that can be visually identified regarding the identified shipping containers. The results of the cloud model analysis may be utilized to populate a dashboard for viewing by a user device of the customer.

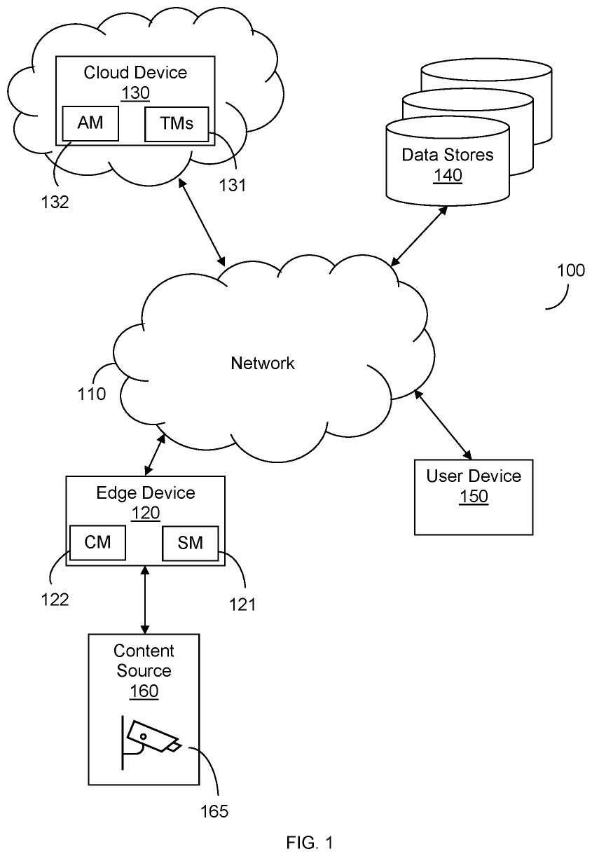

FIG. 1 shows an example network diagram 100 utilized to describe the various disclosed embodiments. In the example network diagram 100, an edge device 120, a cloud device 130, a plurality of data stores (hereinafter referred to individually as a data store 140 and collectively as data stores 140, merely for simplicity purposes), and a user device 150 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

Each of the edge device 120 and the cloud device 130 is configured to perform a respective portion of the embodiments described herein. More specifically, the edge device 120 is configured to apply a student model (SM) 121 and a custom model (CM) 122 to features obtained from content, and the cloud device 130 is configured to apply teacher models (TMs) 131 and an advanced model 132 during training and utilization, respectively. In various embodiments and specifically as depicted in FIG. 1, the edge device 120 and the cloud device 130 are deployed remotely from each other.

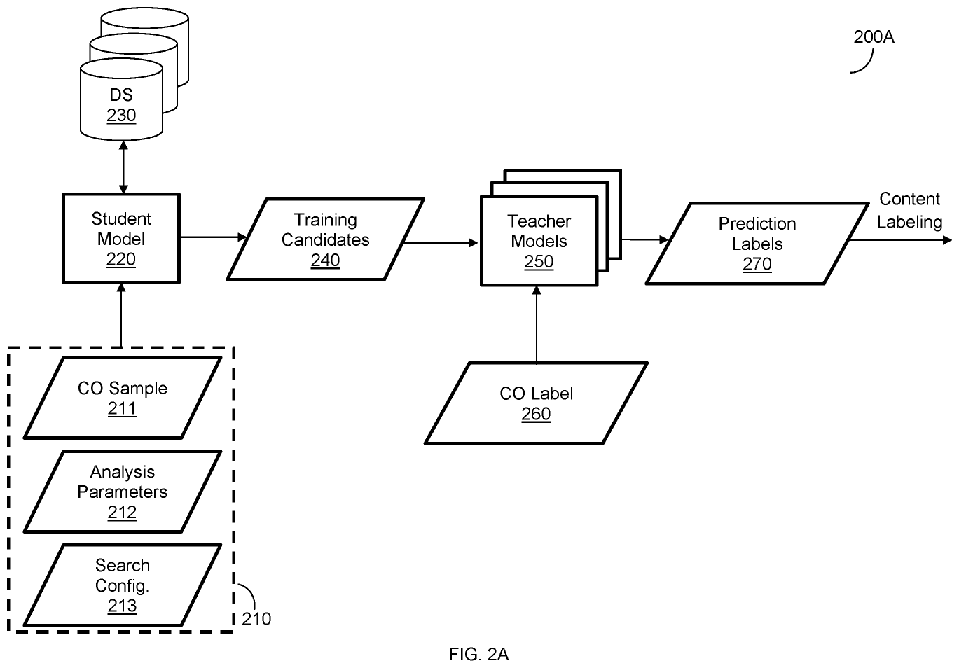

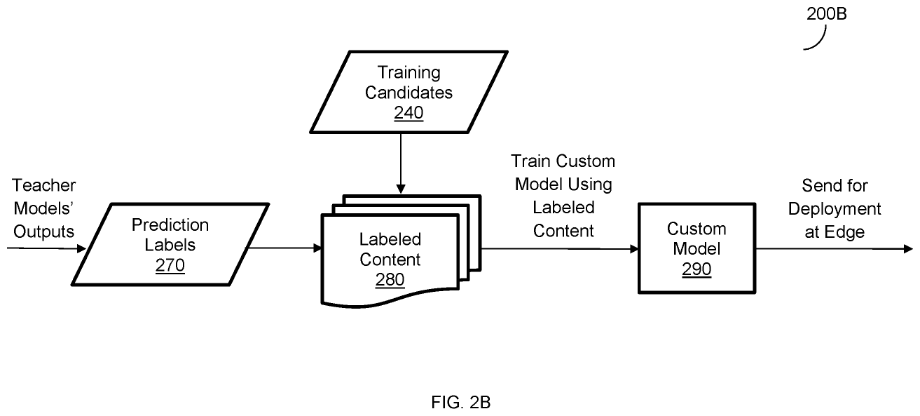

During training, the custom model 122 is created using outputs of the teacher models 131 when applied to select portions of content acting as portions of content acting as training candidates. Specifically, the student model 121 is initially configured to select content to be uploaded to the teacher models 131 using one or more search parameters (e.g., the search configuration parameters 213, FIG. 2A) such as, but not limited to, search parameters defining random sampling parameters or search parameters defining other conditions for selecting content such as detection of motion corresponding with the capturing of the content. To this end, the training candidates may be selected from among content from a content source 160. The training candidates may be labeled using prediction labels output by the teacher models 131 in order to create labeled content for use in training the student model 121.

A model is trained using the labeled training candidates produced by the teacher models 131 in order to create a custom model 122. The custom model 122 is sent to the edge device 120 for deployment as a basic model which performs initial analysis to determine whether to further analyze portions of content by an advanced model (AM) 132 deployed in the cloud device 130.

The data stores 140 store content which may be used during training, for example, in order to select training candidates to be used for creating the custom model 125. Such content may include, for example, visual content illustrating objects to be analyzed. As a non-limiting example, the visual content may include video or image content showing a factory or warehouse, where some portions of the video or images show objects produced in the factory or shipped from the warehouse which might be recognized via the custom model 125 and are analyzed further by the advanced model 132 as described herein.

The user device (UD) 150 may be, but is not limited to, a personal computer, a laptop, a tablet computer, a smartphone, a wearable computing device, or any other device capable of receiving and displaying notifications, portions of visual content, metadata, and the like. In various implementations, modified content created by the edge device 120 or the cloud device 130 may be sent to the user device 150, and the user device 150 may be configured to display a dashboard containing such modified content.

In various embodiments, the user device 150 receives user inputs through one or more user interfaces (not shown). These user inputs include inputs defining custom objects as well as criteria for selecting training candidates such as, but not limited to, a content sample showing the custom object, analysis parameters defining how portions of content are to be analyzed when identifying instances of the custom object, search configuration information defining criteria for selecting training candidates, and the like.

The content source 160 includes (as shown) or is communicatively connected to (not shown) one or more sensors 165 such as, but not limited to, cameras. In accordance with various implementations, the content source 160 may be deployed “on-edge,” that is, locally with the edge device 120 (e.g., through a direct or indirect connection such as, but not limited to, communication via a local network, not shown in FIG. 1). Accordingly, the content captured or otherwise collected by the content source 160 may be analyzed initially using the custom model 122 at the edge, and then only certain portions of content determined to be of interest using the custom model 122 may be sent to the advanced model 132 for further processing. Further, in some implementations, the content used during training and from which the training candidates are selected may be captured by the sensors 165 or may otherwise be provided by the content source 160.

It should be noted that various disclosed embodiments discussed with respect to FIG. 1 are described with respect to a cloud device 130 which is deployed remotely from an edge device 120, but that the disclosed embodiments are not necessarily limited as such. The systems utilizing the student model and the teacher models from the training may be deployed locally to each other, and may communicate over a local connection (e.g., via a local network). Likewise, the systems using the custom model and the advanced models may be deployed locally to each other without departing from the scope of the disclosure. The disclosed embodiments may still yield savings on processing when a first stage of processing is performed using the custom model, and using the custom model to decide which portions of visual content to send to the advanced model may reduce use of networking or other communication resources even when the systems storing and using the different models are deployed locally.

FIGS. 2A and 2B are flow diagrams 200A and 200B, respectively, illustrating creation and deployment of custom models in accordance with various disclosed embodiments.

FIG. 2A is a flow diagram illustrating a first part of the process in which prediction labels are generated for training candidates. As depicted in FIG. 2A, a set of customization inputs 210 are provided to a student model 220. The customization inputs 210 may include, but are not limited to, a custom object (CO) sample 211, analysis parameters 212, and search configuration (config.) parameters 213. The customization inputs 210 may be provided as user inputs.

The sample 211 is a sample of content such as an image showing the custom object. The analysis parameters 212 may be utilized to define potential areas of interest within content such as, but not limited to, parameters indicating that the entire content should be analyzed for the custom object or parameters defining certain zones within content to be analyzed for the custom object. The search configuration parameters 213 define sampling parameters, search terms, or other parameters to be used in order to obtain and identify training candidates. For example, the search configuration parameters 213 may include a randomized sampling scheme (e.g., time intervals at which random samples should be selected from among content) or motion-based sampling parameters (e.g., parameters indicating that samples should be taken at times where motion is detected). The search configuration parameters 213 may further include source identifiers indicating sources from which content should be obtained.

Using the search configuration parameters 213, the student model 220 is configured to obtain content and to select training candidates 240 from among the content. To this end, the student model 220 may access one or more data sources (DS) 230, for example data sources indicated by source identifiers among the search configuration parameters 213. The student model 220 takes samples in the form of the training candidates 240 from among the data obtained from the data sources 230. In various embodiments, the training candidates 240 include the custom object sample 211 which was provided to the student model 220.

The training candidates 240 are uploaded or otherwise provided to teacher models 250. The teacher models 250 also provided a custom object (CO) label 260, which is a custom-defined label to be used for labeling instances of the custom object identified in content, and may be provided as user inputs. The teacher models 250 are configured to output predictions, for example in the form of prediction labels 270, for respective portions of content. As a non-limiting example, the custom object label 260 is output as a prediction label 270 for each portion of content showing the custom object.

In at least some implementations, the custom object label 260 may be an instance of labels associated with other content showing examples of the user-defined custom object such as, but not limited to, sample content obtained via the Internet. As a non-limiting example, the custom object label 260 may be determined by retrieving sample images showing the custom object and analyzing the tags of such images to identify a tag which should be used as the custom object label 260 (e.g., a tag which appears on every sample, the majority of samples, or otherwise meeting some criteria relative to the total set of samples).

FIG. 2B shows the creation of a custom model 290 using the outputs of the teacher models 250. As noted above, the teacher models outputs prediction labels 270. The prediction labels 270 are combined with their respective training candidates 240 in order to produce labeled content 280. The labeled content 280 may be used to train the teacher models 250, and the trained teacher models 250 are utilized to train a custom model 290, for example using one or more transfer learning techniques. Once the custom model 290 is created through this training, the custom model 290 is sent for deployment, for example at the edge device 120, FIG. 1.

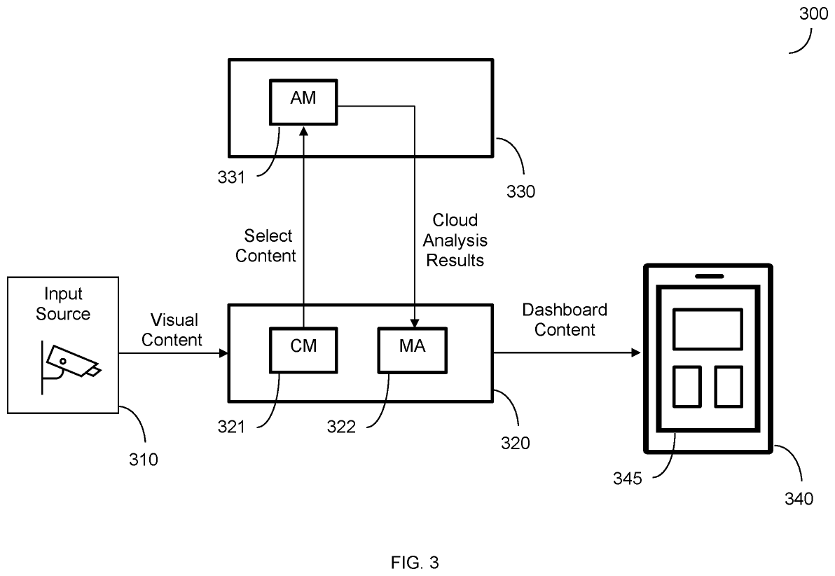

FIG. 3 is a flow diagram 300 illustrating a method for utilizing a hybrid machine learning architecture to efficiently process visual content between distributed systems in accordance with various disclosed embodiments.

In FIG. 3, an input source 310 provides content to be analyzed using a custom model (CM) 321 of an edge device 320 and an advanced model (AM) 331 of a cloud device 330. In accordance with various disclosed embodiments, the custom model 321 is configured to make predictions about the content when applied to features of the content. In turn, the edge device 320 is configured to utilize those predictions in order to determine which portions of the content from the input source 310 should be sent to the advanced model 331 for further analysis. For example, classes associated with the custom object defined for the custom model as described herein may be determined as interesting and sent to the advanced model 331 for further analysis. In turn, the results of the further analysis may be returned to the edge device 320 and combined with the results of the basic analysis performed on the edge device 320 in order to generate content for populating a dashboard 345 on a user device 340.

Further, the edge device 320 may be configured to modify the content from the input source 310. As a non-limiting example, images from the input source 310 may be cropped to remove uninteresting portions. In various embodiments, only the modified content may be sent to the advanced model 331 for further analysis, thereby conserving computing resources for processing such modified content as compared to larger portions of content (e.g., cropped out portions of images instead of entire images).

In various embodiments, outputs of the advanced model 331 are returned to the edge device 320 for further use. In particular, the edge device 320 may also have installed thereon a metadata analyzer (MA) 322 which is configured to analyze the outputs of the advanced model 331 as metadata for the respective interesting portions of content identified by the custom model 321.

The edge device 320 may be further configured, for example, to enrich or otherwise modify the content using the output of the advanced model 331 in order to provide enriched content which may be displayed, for example, on a dashboard 345 of a user device 340. In some implementations, the dashboard 345 may show various portions of the content, specifically the portions identified by the custom model 321 as potentially interesting. In some further implementations, the content displayed on the dashboard 345, when interacted with (for example, by clicking, tapping, etc.) may be enhanced using the enrichment metadata.

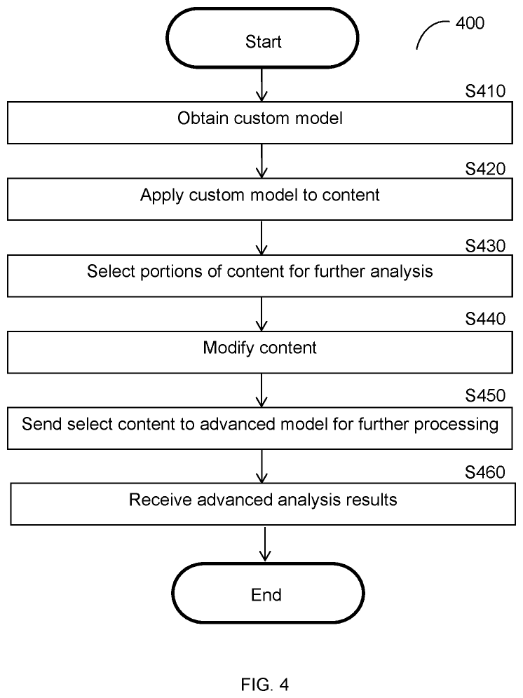

FIG. 4 is a flowchart 400 illustrating a method for processing visual content at an edge of a distributed architecture according to an embodiment. In an embodiment, the method is performed by the edge device 120, FIG. 1.

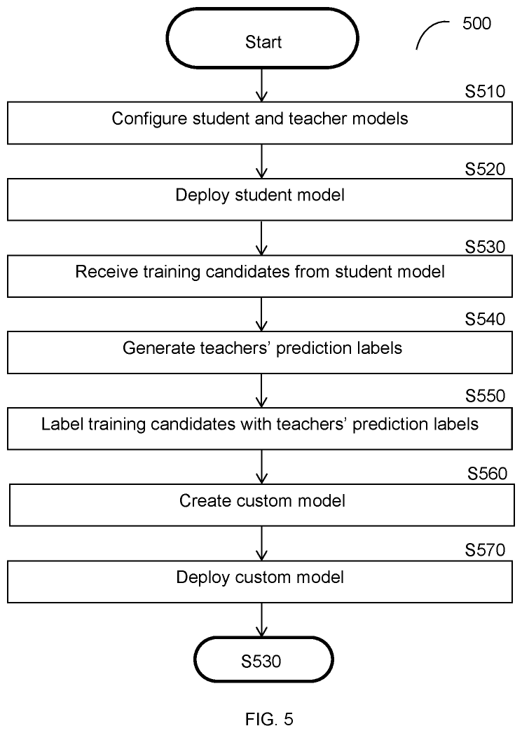

At S410, a custom model is obtained. The custom edge model may be received, for example, from a cloud device (e.g., the cloud device 130, FIG. 1). In various embodiments, the custom model is created as described herein, for example as discussed below with respect to FIG. 5.

Specifically, teacher models may be applied to features of content in order to generate teacher predictions for training candidates uploaded based on outputs of a student model, and content labeled using predictions by the teacher models may be utilized to train a custom model such that the custom model becomes trained to make similar predictions to the teacher models, albeit in a potentially different domain. In particular, the domain (i.e., the universe of potential features) used by the custom model may be a smaller set of features than that of the teacher models. The student model is initially configured with parameters used for searching within content for training candidates as discussed above such that the student model is configured to select training candidates from among content. The resulting custom model trained in this manner may be received and then deployed at the edge device.

At S420, the obtained custom model is applied to features of content in order to generate a first set of predictions. The first set of predictions may be in forms such as, but not limited to, outputs of classifications reflecting labels known to the custom model, at least some of which may be custom-defined labels representing custom objects.

In an embodiment, the custom model is deployed at and stored on an edge device such as the edge device 120, FIG. 1. In a further embodiment, the edge device is deployed locally to a source of the content to be analyzed (e.g., the content source 160, FIG. 1) and is communicatively connected to that source of content so as to obtain the content to be analyzed. To this end, the edge device may communicate locally with that source using local communication channels such as, but not limited to, a wired connection, wireless direct connections (e.g., Bluetooth), local network connections (e.g., via a local area network), and the like.

At S430, portions of the content to be further analyzed are selected. In an embodiment, at least a subset of the potential predictions which can be output by the custom model are predetermined as a set of predetermined predictions to be further analyzed. More specifically, predictions which are of interest based on predetermined designations such as inputs from one or more users are defined in rules used for determining which portions of content are to be further analyzed. To this end, S430 may include applying such rules to the first set of predictions in order to determine whether each portion is among the set of predetermined predictions to be further analyzed.

At optional S440, at least some of the content may be modified. As a non-limiting example, image content may be cropped to only include the portions of the images which were identified as interesting and to be further analyzed at S430. As a non-limiting example, an image including a shipping container as the custom object may be cropped to include only the portion showing the shipping container.

At optional S450, some or all of the content may be sent to an advanced model (e.g., the advanced model 132, FIG. 1) for further processing. More specifically, portions of content which were selected for further analysis at S430 are sent to be further analyzed. When the content is images, the sent content may include images containing portions identified as interesting at S430 or portions of the image identified as interesting cropped out of their respective images.

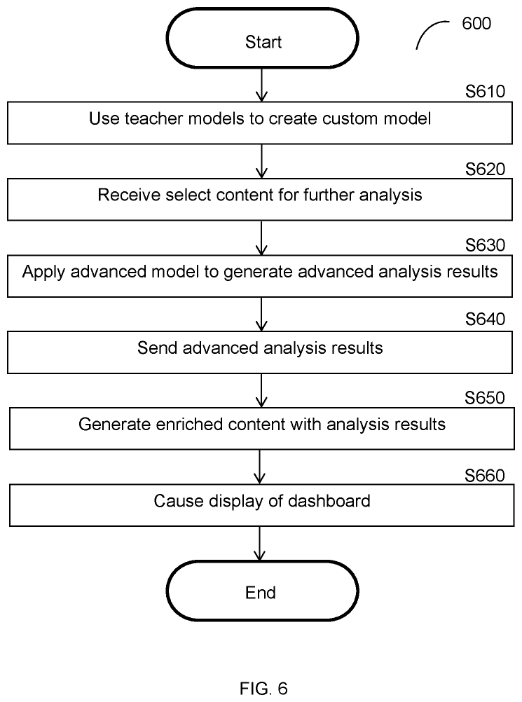

At S460, advanced analysis results are received from the advanced model. The advanced analysis results may include or otherwise be based on advanced model predictions made by a cloud model such as, but not limited to, the advanced model 132, FIG. 1. In an example implementation, the advanced model predictions may be generated as described further below with respect to FIG. 6.

FIG. 5 is a flowchart 500 illustrating a method for creating a custom model according to an embodiment. In an embodiment, the method is performed by the cloud device 130, FIG. 1.

At S510, student and teacher models are configured. Each of the student and teacher models is a machine learning model configured to output predictions for portions of content. In an embodiment, the teacher model is a classifier model to be trained via supervised machine learning using a training set including example features of content and respective labels representing known classifications. In another embodiment, the student model is initially configured to classify portions of content as either training candidates or not training candidates based on a sampling scheme or other parameters for selecting training candidates provided as user inputs such as the search configuration parameters 213, FIG. 2A.

The teacher models are configured with a first domain, i.e., a first set of potential values that are recognized by the teacher model. The potential values recognized by the teacher model are values which can be input to the teacher models in order to produce teacher predictions, for example, values which correspond to variables within the teacher models. The initial configuration of the student model is based on a second domain, i.e., a second set of potential values that are recognized by the student model. The second domain of the student model may be a subset of the first domain of the teacher models. As a non-limiting example, the student model may be configured only to classify objects shown in images into one or more types of objects (e.g., container or not container), while the teacher models may be configured both for such object type classification and to classify other characteristics of objects shown in the images such as identifiers or other strings of characters shown on the object (e.g., a container identifier on a shipping label affixed to a container).

In an embodiment, the teacher models include one or more text-to-visual teacher models trained to convert text into labeled visual media content. In a further embodiment, such text-to-visual teacher models are trained to translate textual data into custom-labeled data such that these teacher models are adapted to label visual content using text. To this end, the teacher models may be trained to recognize object classes which were not observed during training (e.g., which are not explicitly included in the training data set), for example but not limited to, by leveraging semantic relationships between known and unknown classes. To this end, in some non-limiting example implementations, the training models utilize zero-shot object detection techniques which may include using a pre-trained language model to learn a semantic embedding space in which objects are represented as vectors based on their attributes and relationships to other objects. When applied to test data, a zero-shot detection algorithm utilizing such a trained model can recognize previously unseen classes by mapping their attributes to the embedding space and identifying the closest neighbors among known classes.

At S520, the student model is sent for deployment at an edge device (e.g., the edge device 120, FIG. 1). Once deployed at the edge device, the student model is used to select training candidates from among content as described above.

At S530, training candidates selected by the student model are received from the student model. The training candidates may be identified based on outputs of the student model, for example, outputs of certain classes which are predetermined to be potentially interesting and therefore candidates for further analysis.

It should be noted that the training candidates received from the student model are selected automatically and without requiring human intervention. By using the student model to select the content for further analysis during the training, such selection can be performed without requiring selection by a human operator. Moreover, since the student model is used for selection without requiring a human involved, privacy of the data can be maintained during the training process.

At S540, teacher prediction labels are generated based on teacher predictions for the obtained training content. In an embodiment, the teacher prediction labels include one or more labels corresponding to each portion of the training content. In an embodiment, S540 includes applying the teacher models to the training candidates selected by applying the student model as described above in order to generate a set of teacher predictions. For example, the teacher predictions may include, but are not limited to, predictions of certain classifications for respective portions of the training content features, percentages indicating a likelihood of each classification for each portion of the training content features, or both. In accordance with various disclosed embodiments, at least some of the labels output by the teacher models are custom object labels representing a custom object identified by a user.

At S550, the training candidates are labeled with their respective teacher prediction labels. The result is a set of labeled content.

At S560, a custom model is created using the labeled content. The custom model may be a machine learning classifier trained to output classification predictions including, but not limited to, custom object predictions indicating whether a portion of content shows a custom object. To this end, S560 includes providing the labeled content or features extracted from the labeled content as a training data set to a training program used for training the custom model. In accordance with various disclosed embodiments, the custom model may have a domain (i.e., a set of potential values that are recognized by the custom model) which is a subset of the domain of the teacher models, of an advanced model, or both. Accordingly, the custom model may perform a limited analysis with respect to this domain subset, and may send content for further processing with respect to the full domain by the advanced model.

In an embodiment, the custom model is trained such that the custom model is configured to detect both custom objects corresponding to the custom object labels and one or more predetermined legacy objects known to the teacher models (i.e., one or more types of objects that the teacher models have been previously trained to detect). That is, the custom model may be trained to detect other items aside from just the new custom objects.

In a further embodiment, the labeled content used for creating the custom model is a limited set of content from among the training candidates. More specifically, the labeled content used for creating the custom model may include a number of labeled training candidates that is below a threshold proportion of a total number of training candidates. In this regard, it is noted that, in at least some implementations, having too high of a proportion of labeled candidates may interfere with the training process and decrease the accuracy of the model. More specifically, when the custom model is trained to detect both custom objects and previous non-custom objects, training the custom model using a disproportionate number of samples of the custom object may bias the model in a manner that makes detection of the previous non-custom objects less accurate. Limiting the proportion of labeled content used for creating the custom model therefore allows for ensuring that the accuracy of the model is maintained, particularly when the custom model is trained to detect both custom and non-custom content.

At S570, the custom model is sent for deployment. The custom model may be sent, for example, to the edge device 120, FIG. 1. Once deployed at its destination, the custom model may be used to make basic predictions about content such as whether the content tentatively appears to include the custom object. Portions of content determined to show the custom object using the outputs of the custom model may be sent for further analysis by an advanced model as described herein.

FIG. 6 is a flowchart 600 illustrating a method for processing visual content at a cloud analyzer of a distributed architecture according to an embodiment. In an embodiment, the method is performed by the cloud device 130, FIG. 1.

At optional S610, a cloud model is used to create a custom model in order to make predictions in line with the predictions made by the cloud model. In an embodiment, the custom model may be created at least partially as described above with respect to FIG. 5. It should be noted that the creation of the custom model is depicted as part of the process of FIG. 6 merely for illustration, and that the creation of the custom model may be performed as part of an entirely separate process without departing from the scope of at least some disclosed embodiments.

At S620, content or portions thereof to be further analyzed by an advanced model is obtained. As noted above, the content or portions thereof include portions identified as potentially interesting based on predictions for the content made by a custom model. The content or portions thereof may include the content itself, subsets of the content, features extracted from the content, and the like.

At S630, the advanced model is applied in order to generate advanced analysis results. The analysis results may include, but is not limited to, one or more advanced predictions for each portion of the content being analyzed by the advanced model.

At S640, the advanced analysis results are sent for subsequent use. For example, the results may be sent to a system (e.g., the edge device 120) for use in enriching the portions of content as discussed above.

At optional S650, a set of enriched content may be generated using the advanced analysis results. The enriched content may include objects of the content (e.g., images) including interesting portions or the interesting portions themselves (e.g., cropped images, video clips, etc.), enriched with metadata related to the enriched content. More specifically, the enriched metadata may include metadata describing the student predictions, the teacher predictions, or both. As noted above, the teacher predictions may be selected from a larger set of potential outputs than that of the student model, from different sets of potential outputs than those of the student model, or both. The enriched content may be, but is not limited to, various portions of content each with one or more associated interactable elements and corresponding metadata. Also noted above, the enriched content may be generated by the device or system which received the advanced analysis results sent at S640.

At optional S660 a dashboard including the enriched content may be caused to be displayed. To this end, S660 may include sending the enriched content for use with populating such a dashboard or generating the dashboard including the enriched content.

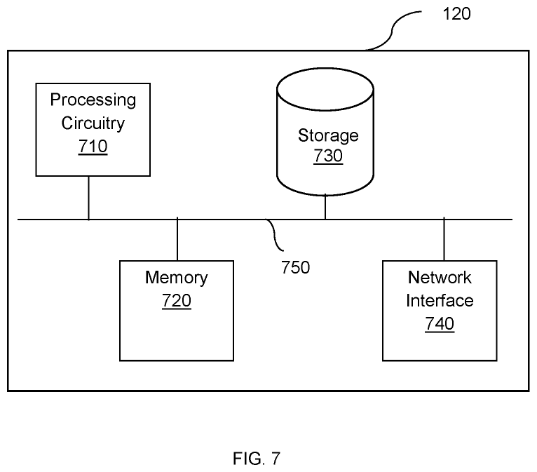

FIG. 7 is an example schematic diagram of an edge analyzer 120 according to an embodiment. The edge analyzer 120 includes a processing circuitry 710 coupled to a memory 720, a storage 730, and a network interface 740. In an embodiment, the components of the edge analyzer 120 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information. The storage 730 may store, among other things, a teacher model (e.g., the cloud model 135) configured and utilized as described herein.

The network interface 740 allows the edge analyzer 120 to communicate with, for example, the cloud analyzer 130, the data stores 140, the content source 160, combinations thereof, and the like.

It should be understood that the embodiments described herein are not limited to the specific architecture illustrated in FIG. 7, and other architectures may be equally used without departing from the scope of the disclosed embodiments.

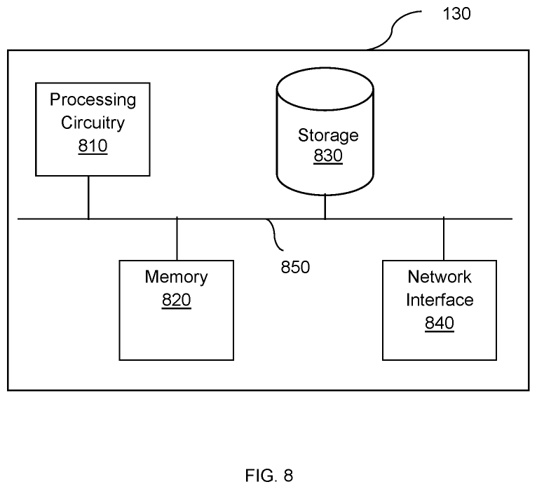

FIG. 8 is an example schematic diagram of a cloud analyzer 130 according to an embodiment. The cloud analyzer 130 includes a processing circuitry 810 coupled to a memory 820, a storage 830, and a network interface 840. In an embodiment, the components of the edge analyzer 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information. The storage 830 may store, among other things, a student model (e.g., the cloud model 135) trained and utilized as described herein.

The network interface 840 allows the cloud analyzer 130 to communicate with, for example, the edge analyzer 120, the data stores 140, the content sources 160, combinations thereof, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for visual content processing, comprising:
applying at least one teacher model to a set of training candidates in order to output a plurality of instances of a custom object label, wherein the set of training candidates is selected using a student model, wherein the student model is configured to select the set of training candidates from among a set of media content based on at least one search configuration parameter, wherein the at least one search configuration parameter defines criteria for selecting samples to be used as the set of training candidates;
generating a first set of media content by labeling the set of training candidates based on the plurality of instances of the custom object label output by the at least one teacher model;
creating a custom model using the at least one teacher model, wherein the custom model is a machine learning model trained using the first set of media content;
obtaining a subset of a second set of media content, wherein the subset of the second set of media content is selected based on outputs of the custom model as applied to the second set of media content, wherein the outputs of the custom model include at least one first prediction for the subset of the second set of media content; and
applying an advanced machine learning model to the obtained subset of the second set of media content, wherein a domain used by the custom model is a subset of a domain used by the advanced machine learning model.

2. The method of claim 1, further comprising:
training the custom model using the at least one teacher model, wherein a domain used by the custom model is a subset of a domain used by the at least one teacher model; and
sending, from a second system to a first system, the trained custom model for deployment as the first machine learning model at the first system, wherein the first system is remote from the second system.

3. The method of claim 2, wherein creating the custom model using the at least one teacher model, further comprises:
labeling at least a portion of the plurality of training candidates with the custom object label based on the output plurality of instances of the custom object label in order to create labeled media content; and
generating the set of second media content based on at least a portion of the labeled media content.

4. The method of claim 3, wherein the custom model is configured to detect custom objects corresponding to the custom object label when applied to features of media content.

5. The method of claim 4, wherein the custom model is a text-to-visual content model trained to detect custom objects corresponding to the custom object label and to detect at least one predetermined object for which the at least one teacher model is trained to detect.

6. The method of claim 5, wherein the at least a portion of the labeled media content is below a threshold proportion of a total number of the plurality of training candidates.

7. The method of claim 3, wherein the second set of media content includes exactly one sample of previously labeled media content.

8. The method of claim 3, further comprising:
selecting the plurality of training candidates from among a third set of media content based on at least one search parameter, wherein the at least one search parameter defines criteria for identifying the third set of media content and for selecting samples from among the third set of media content to be used as the training candidates wherein the set of third media content includes a plurality of portions of media content showing a custom object corresponding to the custom object label.

9. The method of claim 1, further comprising:
enriching the subset of first media content based on the plurality of second predictions to create a set of enriched media content; and
sending the set of enriched media content to be used for populating a dashboard.

10. The method of claim 1, wherein the first machine learning model is applied by an edge device deployed locally with respect to a source of the media content, wherein the second machine learning model is deployed remotely from the edge device.

11. The method of claim 1, wherein each of the first machine learning model and the second machine learning model is a classifier, wherein the first machine learning model is configured to output a plurality of first classes, wherein the second machine learning model is configured to output a plurality of second classes, wherein the plurality of first classes is a subset of the plurality of second classes, wherein each of the plurality of first classes and the plurality of second classes includes a custom object class corresponding to the custom object label.

12. A non-transitory computer readable medium having stored thereon instructions for causing a processing circuitry to execute a process, the process comprising:
applying at least one teacher model to a set of training candidates in order to output a plurality of instances of a custom object label, wherein the set of training candidates is selected using a student model, wherein the student model is configured to select the set of training candidates from among a set of media content based on at least one search configuration parameter, wherein the at least one search configuration parameter defines criteria for selecting samples to be used as the set of training candidates;
generating a first set of media content by labeling the set of training candidates based on the plurality of instances of the custom object label output by the at least one teacher model;
creating a custom model using the at least one teacher model, wherein the custom model is a machine learning model trained using the first set of media content;
obtaining a subset of a second set of media content, wherein the subset of the second set of media content is selected based on outputs of the custom model as applied to the second set of media content, wherein the outputs of the custom model include at least one first prediction for the subset of the second set of media content; and
applying an advanced machine learning model to the obtained subset of the second set of media content, wherein a domain used by the custom model is a subset of a domain used by the advanced machine learning model.

13. A system for visual content processing, comprising:
a processing circuitry; and
a memory, the memory containing instructions that, when executed by the processing circuitry, configure the system to:
apply at least one teacher model to a set of training candidates in order to output a plurality of instances of a custom object label, wherein the set of training candidates is selected using a student model, wherein the student model is configured to select the set of training candidates from among a set of media content based on at least one search configuration parameter, wherein the at least one search configuration parameter defines criteria for selecting samples to be used as the set of training candidates;
generate a first set of media content by labeling the set of training candidates based on the plurality of instances of the custom object label output by the at least one teacher model;
create a custom model using the at least one teacher model, wherein the custom model is a machine learning model trained using the first set of media content;
obtain a subset of a second set of media content, wherein the subset of the second set of media content is selected based on outputs of the custom model as applied to the second set of media content, wherein the outputs of the custom model include at least one first prediction for the subset of the second set of media content; and
apply an advanced machine learning model to the obtained subset of the second set of media content, wherein a domain used by the custom model is a subset of a domain used by the advanced machine learning model.

14. The system of claim 13, wherein the system is further configured to:
train the custom model using the at least one teacher model, wherein a domain used by the custom model is a subset of a domain used by the at least one teacher model; and
send, from a second system to a first system, the trained custom model for deployment as the first machine learning model at the first system, wherein the first system is remote from the second system.

15. The system of claim 14, wherein the system is further configured to:
label at least a portion of the plurality of training candidates with the custom object label based on the output plurality of instances of the custom object label in order to create labeled media content; and
generate the set of second media content based on the labeled media content.

16. The system of claim 15, wherein the custom model is configured to detect custom objects corresponding to the custom object label when applied to features of media content.

17. The system of claim 16, wherein the custom model is a text-to-visual content model trained to detect custom objects corresponding to the custom object label and to detect at least one predetermined object for which the at least one teacher model is trained to detect.

18. The system of claim 17, wherein the at least a portion of the labeled media content is below a threshold proportion of a total number of the plurality of training candidates.

19. The system of claim 15, wherein the second set of media content includes exactly one sample of previously labeled media content.

20. The system of claim 15, wherein the system is further configured to:
select the plurality of training candidates from among a third set of media content based on at least one search parameter, wherein the at least one search parameter defines criteria for identifying the third set of media content and for selecting samples from among the third set of media content to be used as the training candidates wherein the set of third media content includes a plurality of portions of media content showing a custom object corresponding to the custom object label.

21. The system of claim 13, wherein the system is further configured to:
enrich the subset of first media content based on the plurality of second predictions to create a set of enriched media content; and
send the set of enriched media content to be used for populating a dashboard.

22. The system of claim 13, wherein the first machine learning model is applied by an edge device deployed locally with respect to a source of the media content, wherein the second machine learning model is deployed remotely from the edge device.

23. The system of claim 13, wherein each of the first machine learning model and the second machine learning model is a classifier, wherein the first machine learning model is configured to output a plurality of first classes, wherein the second machine learning model is configured to output a plurality of second classes, wherein the plurality of first classes is a subset of the plurality of second classes, wherein each of the plurality of first classes and the plurality of second classes includes a custom object class corresponding to the custom object label.

24. A method for visual content processing, comprising:
applying a custom machine learning model to a set of first media content, wherein the custom machine learning model is trained using a set of second media content, wherein the set of second media content is generated by labeling a plurality of training candidates based on a plurality of predictions output by a at least one teacher model, wherein the plurality of prediction labels includes at least one instance of a custom object label, wherein the outputs of the custom machine learning model include at least one prediction for the set of first media content;
selecting a subset of the first media content based on the at least one prediction for the set of first media content output by the custom machine learning model; and
providing the selected subset of the first media content as inputs to an advanced machine learning model, wherein a domain used by the custom machine learning model is smaller than a domain used by the advanced machine learning model.

25. The method of claim 24, further comprising:
selecting the plurality of training candidates from among a set of third media content based on at least one search parameter, wherein the at least one search parameter defines criteria for identifying the set of third media content and for selecting samples from among the third set of media content to be used as the training candidates, wherein the set of third media content includes a plurality of portions of media content showing a custom object corresponding to the custom object label.

26. The method of claim 24, wherein each of the custom machine learning model and the advanced machine learning model is a classifier, wherein the custom machine learning model is configured to output a plurality of first classes, wherein the advanced machine learning model is configured to output a plurality of second classes, wherein the plurality of first classes is a subset of the plurality of second classes, wherein each of the plurality of first classes and the plurality of second classes includes a custom object class corresponding to the custom object label.
